(19) United States
(12) Patent Application Publication
(10) Pub. No.: US 2009/0266804 A1
(43) Pub. Date: Oct. 29, 2009

(54) COMBINATION EXTRUSION AND LASER-MARKING SYSTEM, AND RELATED METHOD

(76) Inventors: Darryl J. Costin, Westlake, OH (US); Darryl J. Costin, JR., Avon, OH (US)

Correspondence Address: BERENATO, WHITE & STAVISH, LLC, 6550 ROCK SPRING DRIVE, SUITE 240, BETHESDA, MD, 20817, US

(21) Appl. No.: 12/429,437

(22) Filed: Apr. 24, 2009

Related U.S. Application Data
(60) Provisional application No. 61/047,697, filed on Apr. 24, 2008.

(51) Int. Cl. B23K 26/00

(52) U.S. Cl. 219/121.85; 219/121.6

(57) ABSTRACT

A combination extrusion and laser marking system and corresponding method are provided for creating an extruded article with a surface graphic image. The system includes an extruder, a laser, and a controller or encoder. The extruder is operable to pass an extrudable material through a die and discharge an extrudate having a markable surface. The laser is operable with the extruder for forming an image on the markable surface of the extrudate discharged from the extruder. The encoding system is operable to measure a rate of speed at which the extrudate is discharged from the extruder and provide a feedback signal for controlling operation of the laser. The combination may further include an ink printer to form an additional image on the extruded article.

### CROSS-REFERENCE TO RELATED APPLICATION(S)

This application claims the benefit of priority of provisional application 61/047,697 filed in the U.S. Patent & Trademark Office on Apr. 24, 2008, the complete disclosure of which is incorporated herein by reference.

### FIELD OF THE INVENTION

The present invention relates to a system and method of laser marking extruded articles, and in certain embodiments, to a system and method for on-the-fly laser marking of extruded articles.

### BACKGROUND OF THE INVENTION

There are a number of plastic, aluminum, ceramic, rubber and composite products that are manufactured by extrusion processes. These products include pipes for plumbing, wood composites for building products, profiles for tracks and frames, aircraft components, structural parts, sheets, films, tubing, bricks, play-doh toy products, automotive parts including bumpers, engineered products for the construction industry and many others. Extrusion is the process where a solid material, which may be a polymer or metal, usually in the form of beads or pellets, is continuously fed to a heated chamber and carried along by a feedscrew within. The feedscrew is driven via drive/motor and tight speed and torque control is critical to product quality. As it is conveyed it is melted, compressed, and forced out of a chamber at a steady rate through a die. The immediate cooling of the melt results in resolidification of that material into a continually drawn piece whose cross section matches the die pattern. This die has been engineered and machined to ensure that the melt flows in a precise desired shape.

Examples of extruders products are blown film, pipe, coated paper, plastic filaments for brush bristles, carpet fibers, vinyl siding, just about any lineal shape, plus many, many more. There is almost always downstream processing equipment that is fed by the extruder. Depending on the end product, the extrusion may be blown into film, wound, spun, folded, and rolled, plus a number of other possibilities.

Generally, extrusion begins with a starting material, sometimes in the form of a billet, which is pushed and/or drawn through a die of the desired profile shape. Hollow sections may be extruded by placing a pin or piercing mandrel inside of the die, and in some cases pressure is applied to the internal cavities through the pin. Extrusion may be continuous (producing infinitely long material) or semi-continuous (producing many short pieces). Some materials are hot drawn while others may be cold drawn. The feedstock may be forced through the die by various methods. Augers may be single or twin screw, may be powered by an electric motor, a ram, hydraulic pressure (for steel alloys and titanium alloys for example), or oil pressure (for aluminum), for example. In other specialized processes such as the use of rollers inside a perforated drum may be employed for the production of many simultaneous streams of material.

Plastic extrusion commonly uses plastic chips or pellets, which are usually dried in a hopper before being fed to the auger. The polymer resin is heated to molten state by a combination of heating elements and shear heating from the extrusion screw. The screw(s) forces the resin through a die, forming the resin into an extrudate having a desired shape. The extrudate is cooled and solidified as it is pulled through the die or water tank. In some cases (such as fiber-reinforced tubes) the extrudate is pulled through a very long die, in a process called pultrusion.

A drawback of conventional extrusion processes is the difficulty of creating a graphic design, such as a pattern or decoration, on the extrudate in a convenient and continuous manner. The successful coupling of extrusion and laser-marking equipment into an integrated system has not been accomplished up until now because extrusion equipment typically operates at 10-15 feet/minute line speed, whereas typical laser engraving machines do not scan graphics fast enough to achieve even a 5 foot/minute line speed for product widths of about 6 inches.

### SUMMARY OF INVENTION

According to an aspect of the invention a combination extrusion and laser marking system is provided for creating an extruded article with a surface graphic image. The system includes an extruder, a laser, and a controller or encoder. The extruder is operable to pass an extrudable material through a die and discharge an extrudate having a markable surface. The laser is operable with the extruder for forming an image on the markable surface of the extrudate discharged from the extruder. The encoding system is operable to measure a rate of speed at which the extrudate is discharged from the extruder and provide a feedback signal for controlling operation of the laser.

A second aspect of the invention provides a method of extruding an article and creating an image in a surface of the article, the method comprising the steps of extruding an extrudable material through a die to provide an extrudate; delivering the extrudate to a processing line; lasing a graphic on a surface of the extrudate on the processing line. The system also measures a rate of movement of the processing line and the laser with a controller or encoder, which generates a feedback signal based on the measured rate of movement to provide coordinated movement between the extruder line and the laser. The controller appropriately adjusts the lasing procedure. As such, the controller delivers a feedback signal to the laser system to coordinate the steps of forming the extruded article and applying the laser to form said image.

In another embodiment the laser system etches the graphic image on the extruded part off-line in either an indexed process where the part is moved one section at a time under the laser and the laser etches part of the graphic image or in a continuous print on the fly process where a separate conveyor moves the extruded part into the laser chamber for etching in a continuous process.

Other aspects of the invention, including apparatus, systems, methods, kits and the like which constitute part of the invention, will become more apparent upon reading the following detailed description of the exemplary embodiments and viewing the drawings.

### BRIEF DESCRIPTION OF THE DRAWING(S)

The accompanying drawings are incorporated in and constitute a part of the specification. The drawings, together with the general description given above and the detailed description of the exemplary embodiments and methods given below, serve to explain the principles of the invention. In such drawings:

FIG. 1 is a flowchart of a method for extruding and laser marking a surface of an article according to an embodiment of the invention;

FIG. 2 is a flowchart of a method for extruding and laser marking a surface of an article according to another embodiment of the invention;

FIG. 3 is a flowchart of a method for extruding and laser marking a surface of an article according to yet another embodiment of the invention;

FIG. 4a is a plan view of an extruded plank with a wood grain image lased onto the top surface of the extruded plank prepared according to an embodiment of the invention;

FIG. 4b is a sectional view of the extruded plank of FIG. 4a taken along section line IV-IV;

FIG. 5 is a perspective view of an extruded article lased to resemble a body having a tile surface prepared according to an embodiment of the invention;

FIG. 5a is an enlarged view of an area of the extruded article of FIG. 5;

FIG. 6a is a schematic view of a system for surfacing marking an article with a laser and following an extrusion process according to an embodiment of the invention;

FIG. 6b is a schematic view of a system for surfacing marking an article with a laser and following an extrusion process with an additional step of ink printing according to another embodiment of the invention;

FIG. 7a is a flowchart showing an embodiment for controlling laser scribing using a vector-based system;

FIG. 7b is a flowchart showing an embodiment for controlling laser scribing and printing using a vector-based system;

FIG. 7c is a flowchart showing an embodiment for controlling laser scribing using a raster-based system;

FIG. 7d is a flowchart showing an embodiment for controlling laser scribing and printing using a raster-based system;

FIG. 8 is a schematic view of a laser controller system and laser suitable for operation with the system of FIG. 6a or 6b for scribing a first graphic design in the surface of an extruded article;

FIG. 9 is a schematic view of a printing apparatus of the system of FIG. 6b for printing a second graphic design in the surface of an article;

FIG. 10 is a schematic view of an example of a printing station of the printing apparatus of FIG. 9; and

FIG. 11 is a schematic view of an example of a printer applying ink to an article having a laser scribed channel feature.

### DETAILED DESCRIPTION OF EXEMPLARY EMBODIMENTS AND EXEMPLARY METHODS

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

Generally, in certain exemplary embodiments a method is provided for extruding and marking the surface of an article in which a graphic design element is laser scribed into the extruded article surface. Spatially, registering of multiple graphic design elements such as laser elements and printed elements may involve their superimposition or juxtaposition on the article surface using, for example, predetermined coordinates. Aesthetically, the lased graphic design elements produce a high quality simulation, especially of natural materials, that could not be attained by conventional methods.

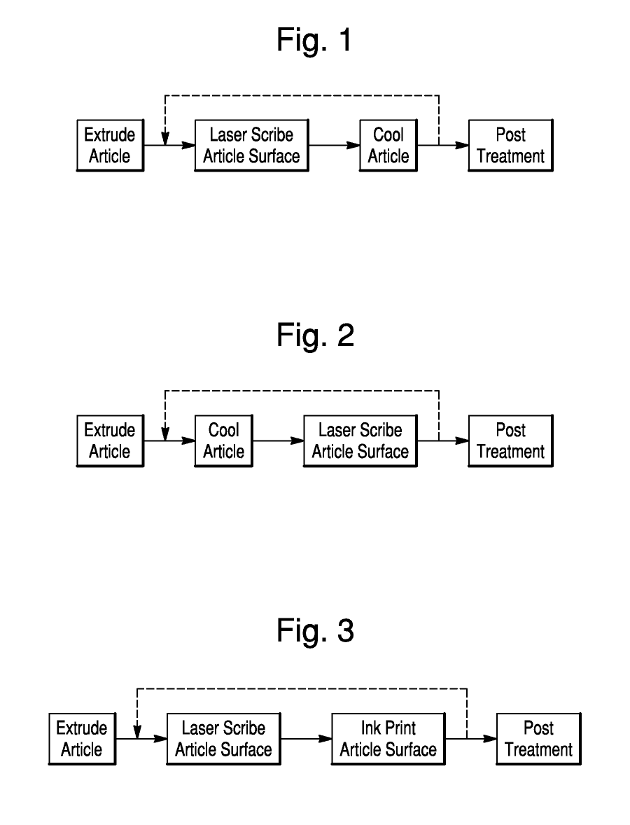

Laser scribing as described herein may be conducted simultaneously with the extrusion process or shortly thereafter. In the embodiment depicted in FIG. 1, the article surface is laser scribed during or immediately after the extrusion process. FIG. 2 depicts an alternative embodiment in which laser scribing occurs after some period of cooling or later processing of the extruded article. FIG. 3 depicts an alternative embodiment in which both laser scribing and ink printing processes are performed on an extruded article. Although not shown in FIG. 3, a cooling stage may be included; e.g., post-extrusion or post lasing as would be understood by those of skill in the art. As represented by the dashed lines in FIGS. 1 to 3, the lasing and/or ink printing of the graphic designs may be repeated and/or conducted in multiple stages. It should be understood that all or less than the entire article surface may be laser scribed, and that, with respect to FIG. 3, all or less than the entire article surface may receive ink printing. In instances in which it is desirable to print ink on lased areas of the article surface, it may be preferable for the laser scribing to precede the ink printing. Further, the type of laser scribing and/or ink printing may dictate when cooling is performed.

Articles that may be subject to marking according to embodiments of the present invention include, for example, extruded plastic, vinyl and composite components as known in the extrusion art. One excellent application of this invention is to impart wood grain patterns with the laser on building material substrates such as decking, siding and trim product substrates from extrusion equipment. Embodiments of the invention also apply to co-extrusion processes where top layers are extruded onto various substrates and the top layers are laser etched in a continuous print on the fly process. For explanatory purposes, exemplary embodiments below are described in relation to siding, trim or molding, and/or an extruded board for decking structures. It should be understood that the methods and systems described herein may be used for marking other building component and articles other than building components. Thus, the lasing process may be used on any suitable extrudable material; e.g., plastic, vinyl, aluminum, and wood composite materials.

Graphic designs referred to herein may encompass decorative and artistic designs. The graphic design may include repeating patterns such as diamond, hounds tooth or chevron patterns, or non-repeating graphic designs, such as floral designs. The graphics may be simple geometric shapes or highly complex shapes and/or alphanumeric information. Graphic designs which simulate the appearance of wood grain patterns, building siding, and routed or mill-worked features; e.g., trim, are particularly applicable. As discussed in greater detail below, exemplary embodiments of the invention permit the marking of advanced, highly aesthetic designs to allow the manufacture of premium products, including those not now available in the marketplace, in an economical manner for high output industrial production.

In the course of laser scribing, a laser beam causes a visually (naked-eye) perceptible change to the article surface, typically by causing removal, ablation, or etching of a coated or uncoated article surface. The visually perceptible change is typically in the form of a recess of a depth that extends partly through the article or article coating, without cutting entirely through the article. (This is not to exempt the use of the laser for separate cutting operations as well.) The recess may be configured as a channel, groove or trench, cavity, or other depression. Alternately, the visually perceptible change may be limited to the surface only, or a color change to a dye contained in a coating applied to the article surface.

The laser beam may be controlled to impart to the recessed area a relatively rough textural feel to an extruded body that closely mimics the actual feel of a non-synthetic processed object such as routed or millwork wood that has not been significantly sanded. If the planar surface of the article is relatively smooth prior to laser etching, this smoothness is maintained at areas of the article surface that are not laser etched, whereas those surface areas that are laser etched may develop a greater coarseness due to the laser etching. The surface topography of the coarse areas may be characterized visually (from a naked eye perspective) as irregular and uneven in many cases. The contrast in texture between adjacent surface areas can contribute to the highly desirable visual impression of the graphic design and add to the overall aesthetic quality of the product. In this way, the laser etching disclosed can provide, for example, slip resistance to extruded plastic lumber to reduce the probability that a person will slip while walking on the plastic lumber.

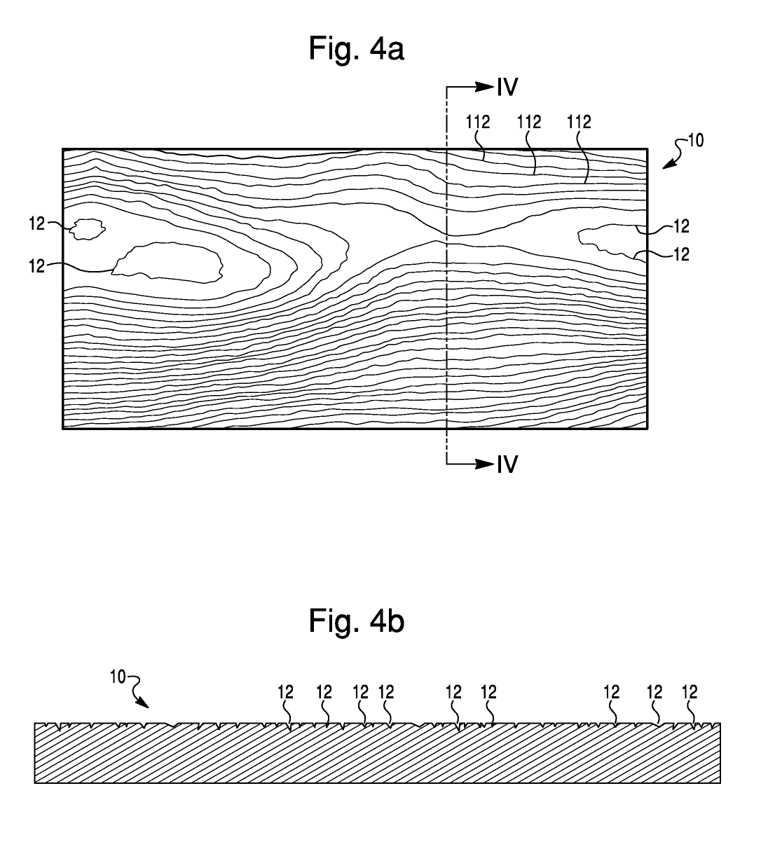

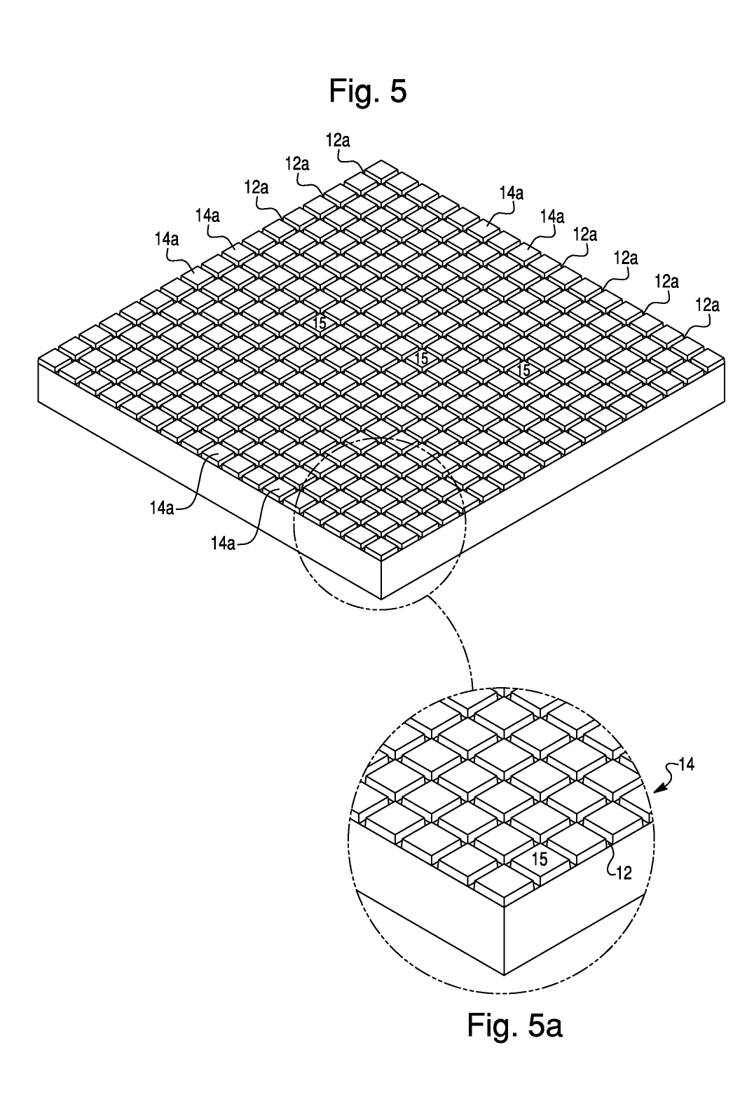

Recesses configured as channels/trenches of elongate length may be arranged on the article surface to create an appearance that the article has been routed, mill-worked, or assembled together from multiple elements, i.e., as opposed to a monolithic structure. In an extruded decking plank 10 shown in FIGS. 4a and 4b, channels 12 provide the wood-grain appearance in the extruded decking plank 10 that is decorated using laser technology to resemble a wooden plank or an article that has been routed or mill-worked. The channels 12a (FIGS. 5 and 5a) may also be configured in deeper rectangular or square contours to define the outlines of tiles 14a. In the tile example of FIGS. 5 and 5a, it is noted and described below the top surface 15 of the artificial tiles 14 may be ink printed, preferably by an inkjet printer, to enhance the aesthetic appearance of the article. It should be understood that the plank structure 10 and the tile structure 14a may contain more or fewer grooves or channels 12, 12a, and that these channels 12, 12a formed in the articles may possess other shapes, and may be identical or different in shape from one another.

Laser scribing may be used to create patterns other than that of wood grain and millwork. As previously described, the recesses laser scribed in an article surface may be arranged in a grid pattern to simulate the edges of ceramic tiles or bricks of a wall or floor structure, with the grid pattern of channels having a rough scribed surface that replicates the appearance of grout or mortar. The texture created by the laser in such channels may be controlled to replicate a visual and tactile impression of coarseness similar to that of mortar or grout, whereas non-lased areas of the product surface remain smooth to closely simulate the appearance and feel of a ceramic. In yet another exemplary embodiment, the recesses may be scribed along non-linear paths to simulate the edges of natural uncut stone, for example. In yet another embodiment, the recesses provide slip resistance to the product.

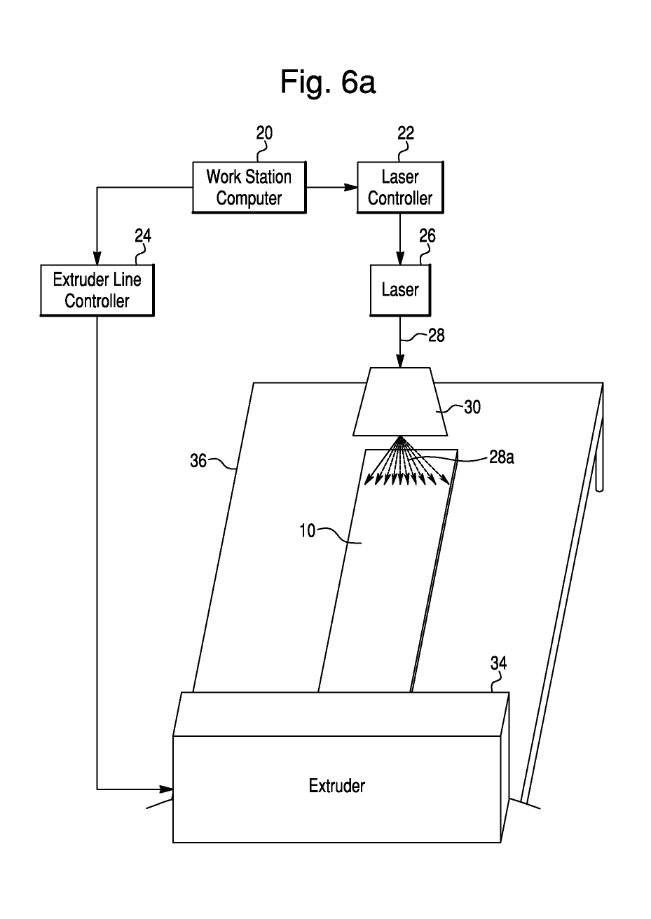

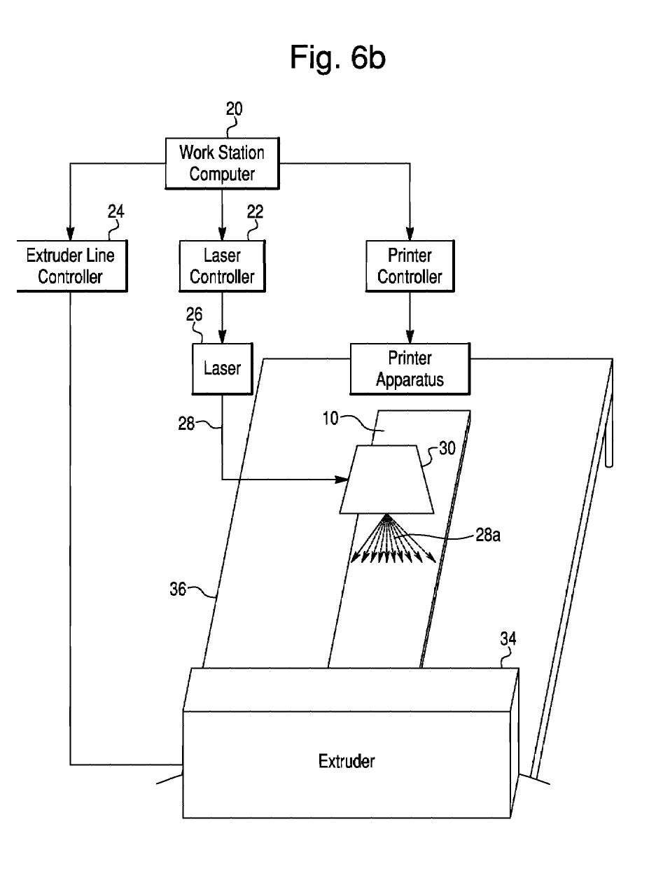

A system for extruding and laser scribing a graphic design on articles such as building components using a high-speed high power laser is shown in FIG. 6a. FIG. 6b shows a system similar to that of FIG. 6a, but modified to further include an inkjet printer. It should be understood that the elements of the systems of FIGS. 6a and 6b described below are exemplary and are not necessarily intended to be limiting on the scope of the invention. Other systems and apparatus may be substituted for those described below, and the system and apparatus described below may be modified as dictated by the nature of the graphic pattern and the article.

As best shown in FIG. 6a, a system according to an exemplary embodiment of the invention includes a work station computer 20 accessible by the operator to specify the overall graphic design to be applied to the work piece, e.g., an extruded floor plank structure 10. The work station computer 20 is in operative communication with a laser controller 22 and an extruder line controller 24. The laser controller 22 communicates with a laser 26 and a laser scanner 30 for directing the path of a laser beam 28 for marking the plank structure 10 located on an extrusion line 36. The extrusion line 36 may be, for example, a continuous belt conveyor or other device for permitting deposition and subsequent movement of the plank structure 10 in a continuous manner. The extruder line controller 24 also communicates with the laser controller 22 through the work station computer 20 to coordinate the speed of the extrusion line 36 with the speed of the laser scanner 30. The work station computer 20 therefore communicates with both the laser 26 and the extruder line 36 to coordinate laser activities (movement and/or power) with the speed and movement of the extrusion line 36. Therefore, the laser 26 and the extruder line 36 may be controlled in tandem, and the operation may be controlled to take into account a cutting process for the extruded article or indexed movement of the extruder line. The cutting process, if included as part of the embodiment, can be carried out in any manner that is known to those of ordinary skill in the art. The speed of the extruder line may be determined by a suitable sensor that detects the speed at which extrudate exits the extruder and then communicates the measured speed to the work station computer 20.

In accordance with embodiments of the invention, the combination extruder and laser etching system provides an indexing capability driven by the work station computer 20 whereby the extrusion line 36 indexes the movement of the extruded article 10 in increments (e.g., one foot at a time) and coordinates with the laser 26 to match the laser etching process to the speed of the extrusion line 36. For example, the indexing process may be determined by the size of the laser etched area on the extruded article 10 (e.g., moving the extruded article in increments of length along the extrusion line 36) or the indexing process may be determined by the size of the extruded article 10 in relation to the cutting process. Therefore, the area to be laser etched is controlled in conjunction with movement or indexing of the extrusion line 36. The indexing process is equally applicable to the embodiment of FIG. 6b having an inkjet printer.

The modified, printer-containing system of FIG. 6b also includes the work station computer 20, which is accessible to the operator to permit the operator to specify a two-part (laser and ink printing system) overall graphic design to be applied to the work piece, e.g., an extruded floor plank structure 10. As with the system of FIG. 6a, the work station computer 20 is in operative communication with the laser controller 22 and the extruder line controller 24. Additionally, in FIG. 6b the work station computer 20 is also in operative communication with a printer controller 25 and printer apparatus 35, such as an inkjet printer. The laser controller 22 communicates with the laser 26 and the laser scanner 30 for directing the path of a laser beam 28. The extruder line controller 24 also communicates with the laser controller 22 through the computer 20 to coordinate the speed of the extrusion line 36 with the speed of the laser scanner 30 to coordinate the laser activities with the speed and movement of the extrusion line 36. The computer 20 additionally communicates with both the printer apparatus 35 and the extruder line 36 to coordinate the ink printer activities with the speed and movement of the extrusion line 36.

The work station computer 20 may be, for example, a personal computer system. Computer hardware and software for carrying out the embodiments of the invention described herein may be any kind, e.g., either general purpose, or some specific purpose such as a workstation. The computer may be a Centrino® or Pentium® class computer, running Windows XP®, Windows Vista®, or Linux®, or may be a Macintosh® computer.

The computer program loaded on the work station computer 20 may be written in C, or Java, Brew or any other programming language. The program may be resident on a storage medium, e.g., magnetic or optical, of, e.g., the computer hard drive, a removable disk or media such as a memory stick or SD media, or other removable medium. The programs may also be run over a network, for example, with a server or other machine sending signals to one or more local machines, which allows the local machine(s) to carry out the operations described herein. Computer aided design (CAD) software can be employed.

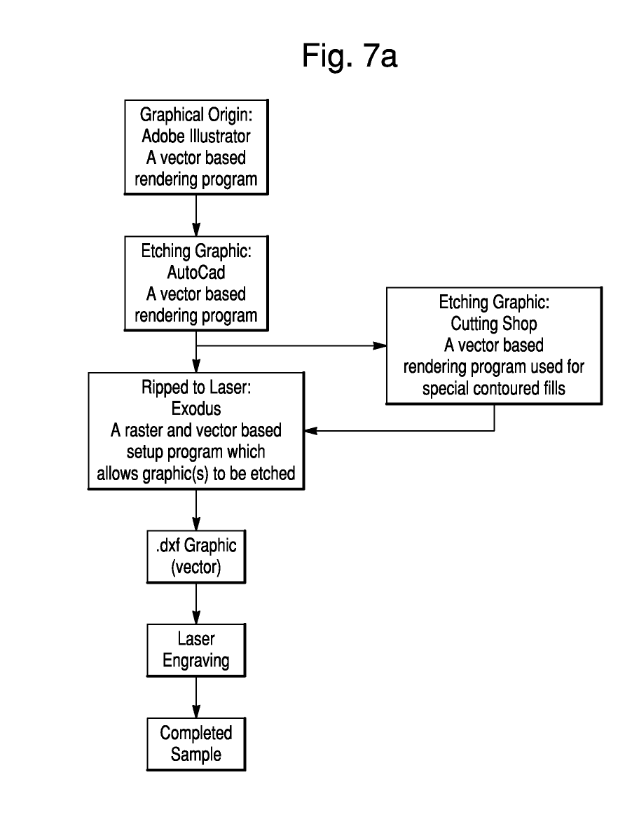

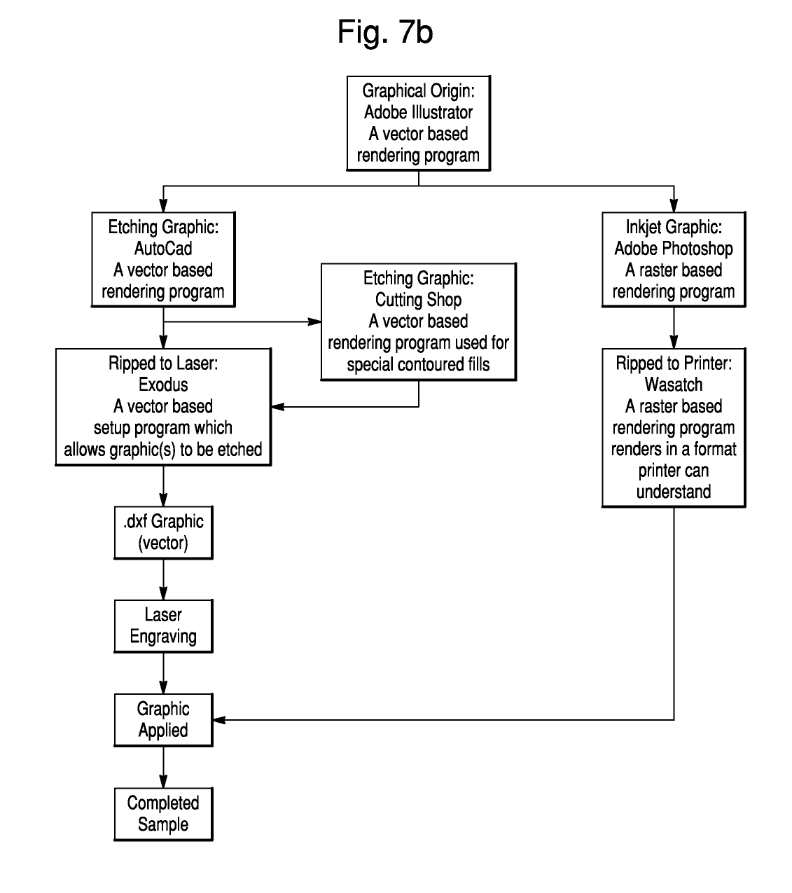

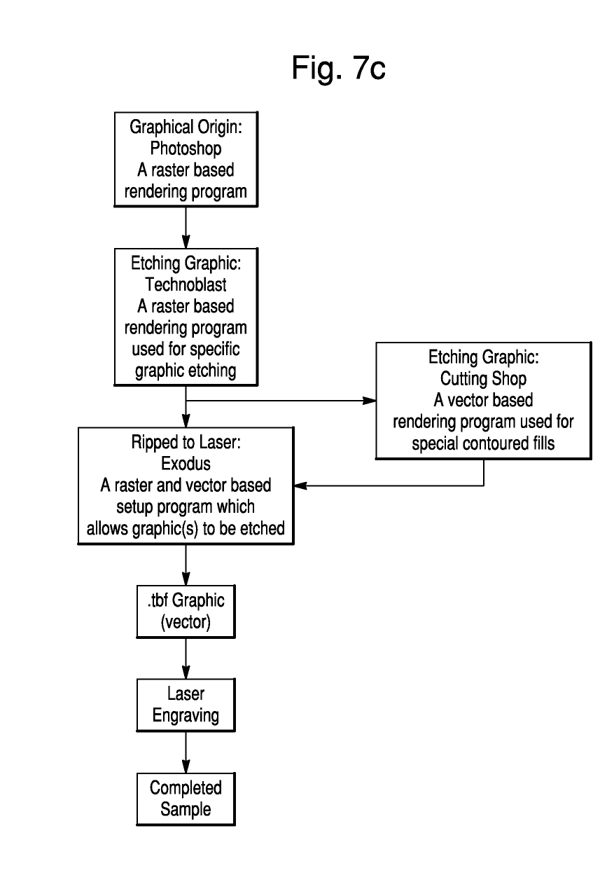

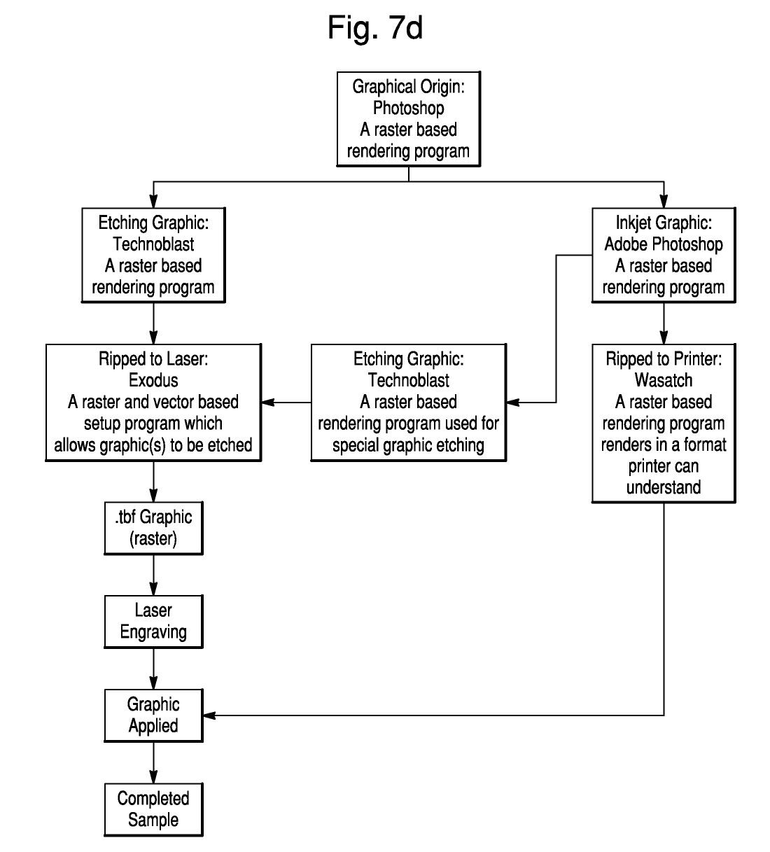

FIG. 7a is a flowchart showing an exemplary method using exemplary software for creating a graphic design and converting the graphic design into computer readable media for the laser controller 22 for laser scribing an image to the extruded article. In the exemplary embodiment of FIG. 7a, the graphic design to be laser inscribed on the substrate is created using Adobe® Illustrator, or any similar vector based rendering program. Alternatively, the graphic design can be input, for example, by scanning a design into the work station computer 20 using an optical scanner or optical reader. The scanned file can be cleaned up manually by the operator or automatically via a software program of the work station computer 20.

FIG. 7b is a flowchart showing an exemplary method using exemplary software for creating a graphic design and converting the graphic design into computer readable media for the laser controller 22 and printer controller 24. In the exemplary embodiment of FIG. 7b, the graphic design to be laser inscribed and printed on the substrate is created using Adobe® Illustrator, or any similar vector based rendering program. Alternatively, the graphic design can be input by, for example, scanning a design into the work station computer 20 using an optical scanner or optical reader. The scanned file can be cleaned up manually by the operator or automatically via a software program of the work station computer 20.

The operator can manually or automatically assign different features or sections of the graphic design for lasing and printing, respectively. Features and/or sections of the graphic design designated for laser scribing are referred to herein as first graphic design elements, whereas features and/or sections of the graphic design designated for printing are referred to herein as second graphic design elements. The first and second graphic design elements may be stored together in a unified image file or separately in respective image files.

In the embodiment shown in FIG. 7b, the graphic design is separated by the operator into an etching graphic template and an inkjet graphic template. The etching graphic template includes those features of the graphic design that will be processed using vector-based programs. Generally, the features that are etched using vector-based programs include lines and curves that define the outlines of the graphic and its major linear and curved features. In FIG. 7b, the vector-based rendering program AutoCAD® developed by AutoDesk®, Inc. is principally employed for this task. In order to make special features such as contour fills that are either difficult or impossible to prepare with AutoCAD®, the additional vector-based program Cutting Shop of Arbor Image Corp. may be used. Cutting Shop is a commercially available product of Arbor Image Corp. promoted for cutting and engraving applications.

The “inkjet graphic” as it is termed in FIG. 7b represents both the coloring of the graphic design and any fill patterns that are not appropriate for vector-based processing. In FIG. 7b, the raster-based rendering program Adobe Photoshop® is used to create a raster file containing coloring (e.g., tone, shading, background color) and printing information. The raster file is “ripped,” that is, converted to a format that the printer controller 24 can interpret, using Wasatch SoftRIP Version 5.1.2 of Wasatch Computer Technologies, Inc.

Referring to FIG. 7c, Adobe Photoshop® is used to create a raster file containing a black and white or gray-scale image of three-dimensional “fill” features such as gradient contours and surface texture. From the gray-scale image, the raster-based program Technoblast® from Technolines LLC creates computer readable instructions for controlling the laser path and power for scribing the “fill” features. The raster- and vector-based program Exodus is used to rip the files received TechnoBlast® programs into a .tbf graphic (raster) file for the laser controller 22. Lasers and printers are typically equipped with appropriate software to convert computer files into the laser and printer manufacturer's language. Alternatively, the graphic design can be input by, for example, scanning a design into the work station computer 20 using an optical scanner or optical reader. The scanned file can be cleaned up manually by the operator or automatically via a software program of the work station computer 20.

Referring to FIG. 7d, Adobe Photoshop® is used to create a raster file containing a black and white or gray-scale image of three-dimensional “fill” features such as gradient contours and surface texture. From the gray-scale image, the raster-based program Technoblast® from Technolines LLC creates computer readable instructions for controlling the laser path and power for scribing the etching “fill” features. The raster- and vector-based program Exodus is used to rip the files received from Technoblast® programs into a .tbf graphic (raster) file for the laser controller 22. Lasers and printers are typically equipped with appropriate software to convert computer files into the laser and printer manufacturer's language. Alternatively, the graphic design can be input by, for example, scanning a design into the work station computer 20 using an optical scanner or optical reader. The scanned file can be cleaned up manually by the operator or automatically via a software program of the work station computer 20.

Returning to FIG. 6a, the laser controller 22 controls the laser scanner 30 to direct the path of laser beam 28a using relatively light weight coated mirrors (discussed below). The laser controller 22 is capable of controlling the movement of the lightweight mirrors of the laser scanner 30 and adjusting power of the laser 26 to direct laser beam output 28 along a path that forms the first graphic image element on the work piece 10. The extruder line controller 24 coordinates the movement and operation of the extruder line 36 with the laser 26 with an encoding system to measure the speed of the extrusion line 36 with feedback to the workstation 20 and laser controller 22.

Referring to FIG. 6b, the laser controller 22 controls the laser scanner 30 to direct the path of laser beam 28a using, for example, relatively light weight coated mirrors (discussed below). The laser controller 22 is capable of controlling the movement of the lightweight mirrors of the laser scanner 30 and adjusting power of the laser 26 to direct laser beam output 28 along a path that forms the first graphic image element on the work piece 10. The extruder line controller 24 coordinates the movement and operation of the extruder line 36 with the laser 26 with an encoding system to measure the speed of the extrusion line 36 with feedback to the workstation 20 and laser controller 22. Additionally, the workstation 20 further controls and communicates with the printer controller 25 to drive the printer apparatus 35 downstream of the laser 26 and laser scanner 30.

With reference to FIG. 6b, the laser scanner 30 and printing apparatus 35 are in close proximity to a working platform or bed 36 that supports the work piece 10, which in the illustrated embodiment is an extruded floor plank 10. The bed 36 along with the work piece 10 is moved relative to the laser beam output 28 and the print head of the printing apparatus 35 to create the desired graphic design. As used herein, relative movement may include movement of the laser beam output 28 and print apparatus 35 print head while retaining the working platform 36 and/or work piece 10 stationary, movement of the working platform 36 and/or work piece 10 while retaining the laser beam output 28 and the print head of the printing apparatus 35 stationary, or combined movement of the laser beam output 28, print apparatus 35 print head, working platform 36 and/or work piece 10. In FIG. 6b the laser scanner 30 is shown “upstream” of the printing apparatus 35. It should be understood that an alternate embodiment may be practiced in which the printing apparatus 34 may be upstream of the laser scanner 30. Further, the system may include multiple lasers and printers.

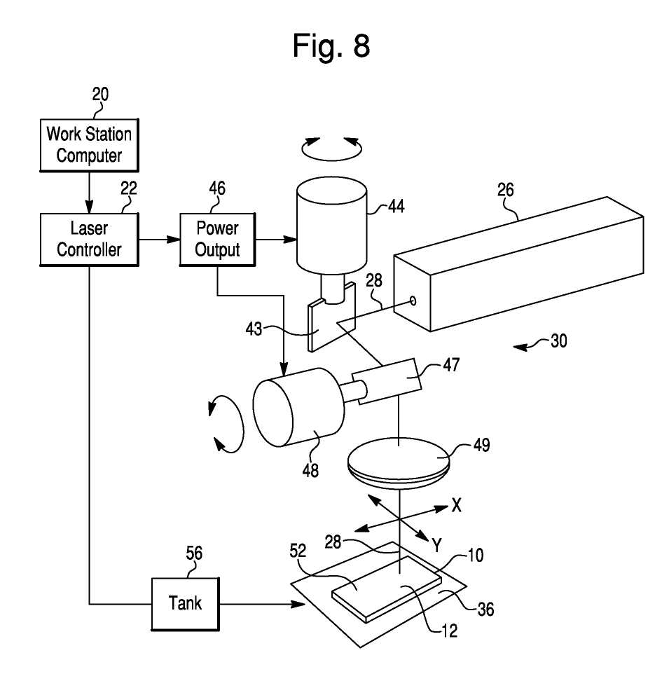

FIG. 8 illustrates an exemplary embodiment of the laser scanner 30 operatively coupled to the laser 26. The laser scanner 30 comprises a computer-controlled mirror system. The illustrated mirror system 30 includes an x-axis mirror 43 rotatably mounted on and driven by an x-axis galvanometer 44. The x-axis galvanometer 44 is adapted to rotate and cause the rotation of the x-axis mirror 43. Rotation of the x-axis mirror 43 while the laser beam 28 is incident on the mirror 43 causes the laser beam 28 incident on mirror 47 to move along the x-axis. The work station 20 and laser controller 22 regulate the output of a power source 46 to control rotation of the x-axis mirror 43 by the x-axis galvanometer 44. The laser beam 28 is deflected by the x-axis mirror 43 and directed toward a y-axis mirror 47 rotatably mounted on y-axis galvanometer 48. The y-axis galvanometer 48 is adapted to rotate and cause rotation of the y-axis mirror 47. Rotation of the y-axis mirror 47 causes movement of the laser beam 28 incident on mirror 47 along the y-axis. The work station 20 and laser controller 22 also regulate the output delivered by the power source 46 to y-axis galvanometer 48 for controlling rotation of the y-axis galvanometer 48 and mirror 47. To create fine resolution graphic designs, the laser controller 22 makes the power changes at high rates. The scan speed of the laser will determine the amount of power changes within the operation of marking the graphic design. The type (e.g., complexity and intricacy) and depth of the graphic will also influence how it is scribed on the work piece 10, which is delivered from an extrusion system.

The laser beam 28 is deflected by the y-axis mirror 47 and directed through a focusing lens 49 adapted to focus the laser beam into an output beam 28a. The lens 49 may be a multi-element flat-field focusing lens assembly, which optically maintains the focused spot on a flat plane as the output beam 28a moves across the work piece 10 to scribe a graphic such as a channel 12. Although not shown, the lens 49, mirrors 43, 47 and galvanometers 44, 48 can be housed in a galvanometer block.

The working platform or bed 36 can be a solid substrate (such as a continuous conveyor belt) or even a fluidized bed. The work piece (such as an extruded floor plank structure) 10 is placed on the working platform 36 downstream of an extrusion device. The work piece 10 includes a viewable, laser-markable and printable surface 52, which in an exemplary embodiment corresponds to the exterior surface of a door skin. The bed 36 can be adjusted vertically to adjust the distance from the lens 49 to the working surface 52 of the work piece 10. The laser beam 28 is directed by the mirrors 43, 47 to cause the output beam 28a to be incident on the working surface 52 of the work piece 10. The output beam 28a is typically directed along a path generally perpendicular to the laser-markable surface 52, but different graphics can be achieved by adjusting the angle between the output beam 28a and the laser-markable surface 52, for example, from about 45° to about 135°. Relative movement between the output beam 28 incident on the laser-markable surface 52 of the work piece 10 causes a graphic such as channel 12 to be scribed on the laser-markable surface 52. As referred to herein, relative movement may involve movement of the output beam 28 (e.g., using the mirror system) as the work piece 10 remains stationary, movement of the laser scan head containing the mirror system as the work piece remains stationary, movement of the work piece 10 while laser output beam 28 remains stationary, or a combination of simultaneous movement of the output beam 28 and the work piece 10 in different directions and/or at different speeds.

According to an exemplary implementation, a graphic image is scanned or otherwise input into the work station computer 20, converted into the proper format, e.g., digitized, and digital information corresponding to the lased features of the graphic image is introduced into the control computer 22 with instructions to laser mark graphic design sections into their corresponding elements. The control computer 22 then controls movement of the galvanometers 44, 48 and mirrors 43, 47 and the power output of the laser 26 to scribe the first graphic element on the working surface 52 of the work piece 10 at the appropriate power, movement velocity for high throughput, and beam spot site. At the same time, the controllers 22, 24 and workstation 20 coordinate the movement of the extruded article along the working platform or bed 36 with the movement and output of the laser. It is noted that the coordinated movement is relative to the longitudinal direction of movement of the extruded article exiting the extruder. The laser controller 22 will also control transverse movement of the laser output 28 and laser beam 28a. The power, beam size, and scan speeds should be controlled in conjunction with the material of work piece 10 and image or channel 12 to avoid any undesirable consequences of over-treatment, such as complete carbonization, burn-through and/or melting of the work piece 10, or under-treatment where the graphic image is not visible or only partially visible. The system can also include a tank 56 to inject a gas such as an inert gas into the working zone. The amount of gas can be controlled by the work station computer 20, laser controller 22, or other apparatus.

In particular exemplary embodiments, 1,000 watt or higher and even 2,500 watt or higher CO₂ lasers coupled to ultra high speed scan heads in excess of 10 meters per second and preferably capable of 30 meters per second or greater speeds offer attractive unit manufacturing costs and economics. Alternatively, the laser may be a YAG laser suitable to lazing metals. Laser power and scan speeds will depend upon the specific substrate extruded and the type and intensity of graphic lazed on the substrate. Laser scan speeds of 30-50 meters per second can etch graphic patterns in time frames measured in seconds per square foot and unit costs measured in pennies per square foot. As referred to herein, “speed” is the speed of the output beam 28a relative to the working surface 52. Relative speed may be controlled by moving the laser output 28 (via scanner 30) while maintaining the work surface 52 stationary, by moving the work surface 52 while maintaining the output beam 28a stationary, or by simultaneously moving the output beam 28a and the working surface 52 in different directions and/or at different rates. In one embodiment, the extruder line is controlled to index the extruded article a predetermined distance along the extruder line, then the article is held stationary while the laser operation is performed within a given area, then the article is again indexed by the same predetermined distance so the an additional lasing operation may be perform at a different area of the article.

According to an exemplary embodiment, a high-speed high power laser is used to form the first graphic element on the work piece surface 52. The laser 26 may be a high power CO₂ laser having greater than 500 W of output power, and in certain exemplary embodiments greater than a 1000 W (1 kW), 2000 W (2 kW) or even greater than 2500 W (2.5 kW). The laser power output referred to herein is continuous, as distinguished from the power output when a laser has a temporary energy surge, or when the laser is pulsed. The continuous power can be varied by adjusting the power setting on the laser 26. The laser 26 frequency is typically in the range of, for example, 10 to 60 kHz. An exemplary commercial laser system is available from LASX (e.g. model number LPM 2500) which utilizes a Rofin-Sinar Technologies, Inc. 2.5 kW CO₂ laser, model number DC025.

In an exemplary embodiment, the laser scanner 30 is capable of producing speeds greater than 10 meter per second, or even 30 meter per second or greater. As described herein, scan speeds of up to 65 m per second or even higher may be employed across the working surface 52.

In order to provide a laser system with 1,000-2,500 watts that is galvo driven at high scan speeds, e.g., ranging from 10-50 meters/second, lightweight high technology mirror systems with high temperature coatings as commercially available are particularly useful. An exemplary commercially available lightweight high technology mirror system is ScanLab AG, Model PowerSCAN33 Be, 3-axis Galvanometer scanner with 33 mm Be Mirrors. The high temperature coating is believed to be a physical vapor deposited alloy. The lightweight beryllium substrate is coated with materials allowing the mirror surface to reflect over 98% of the CO₂ wavelength, 10.6 microns. The lightweight high technology mirror systems allow the galvanometers (or “galvos” for short) to move the output beam 28a in a repeatable but efficient fashion over the work piece surface 52. The scan speed of such a laser system is surprisingly an order of magnitude higher than the laser speeds achieved with either linear drives or conventional galvo mirrors. Using such a lightweight mirror system, laser scan speeds in excess of 65 meters per second can be achieved compared to maximum scan speeds of 4-5 meters per second with conventional laser engraving technology.

For example, laser etching an extruded lumber article in a continuous process for extrusion production may involve one 2,500 watt CO₂ laser directed at a working surface of 50.8 cm (20 inches) that operates at high speeds to match the line speed of the process. But to properly laser etch extruded wood composite or plastic composite planks for mass production that are some 1 foot by 8 foot in size, it may be more efficient to employ multiple lasers or a linear motor to cover the entire working surface. Regardless of the setup, laser powers of 500 watts or higher (e.g., 500-2,500 watts) and laser scan speeds of 10 meters per second on higher (e.g., from 10-50 meters per second) produce satisfactory economics in unit costs for lazing graphics on building products. The actual unit costs could be reduced from dollars-per-square-foot to cents-per-square-foot by increasing the laser speed from the industry standard 3.8 meters per second to, for example, 50 meters per second.

It should be understood that methods embodied herein may be carried out using various other laser systems and scanning devices having modified and alternative layouts and elements to that shown in FIG. 8. Examples of laser systems are disclosed in U.S. Patent Application Publication No. 2007/0108170 to Costin et al. and WO/2008/156620 to Costin et al., the complete disclosures of which are incorporated herein by reference.

The printing apparatus 34 is provided for printing an image on the object, such as the extruded plank 10, e.g., floor plank. The plank structure 10 is supported on the bed 36, which may be the same bed or different bed used to support the door structure 10 during laser scribing. Preferably the bed 36 is capable of supporting multiple objects and moving the objects relative to the printing apparatus 34 for continuous manufacturing.

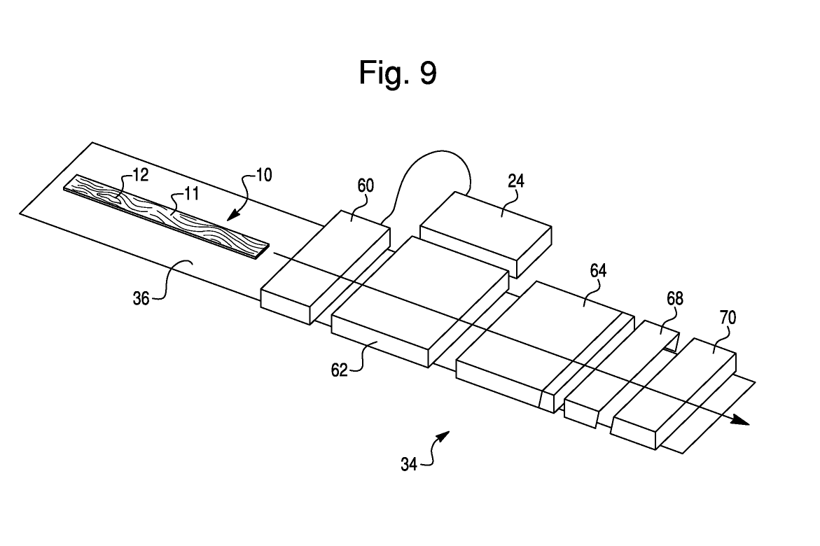

Referring to FIG. 9, the printing apparatus 34 may also include a coating station 60 for spraying or otherwise applying a ground coat to the exterior surface of the work piece 10, e.g., extruded plank structure. Multiple ground costs may be applied to the exterior surface of the plank structure 10, such as a first ground coat on one portion of the planar portion 11 and a second ground coat in the channels 12. The second ground coat in the channels 12 may provide a suggestion of shadowing. A darker tone in the channels 12 may provide a richer appearance. The ground coat(s) may comprise a colored paint, such as a color simulating a wood tone such as mahogany. The coating station 60 may be in the form of a manual spray gun or robotic sprayer. If a wood grain pattern is to be printed or lased, the ground coat(s) may contribute to replication of the background tone of the wood grain pattern.

The ground coat or coats is/are then cured or dried at a drying station 62. The drying station 62 may include an induction radiation heater for drying the ground coat, or some other pigment drying device.

The plank structure 10 is then forwarded to a printing station 64 and the selected image is ink jet printed on the exterior face of the door structure 10. In this exemplary embodiment the ink is UV-curable, for example Sericol UJviJet curing ink. The ink is then cured using a UV-curing lamp 66, which is incorporated into the printing station 64.

A topcoat or protective layer, such as a UV curable coating, may then be applied at a topcoat station 68. The topcoat may be, for example, a clear varnish. The topcoat may be sprayed or otherwise applied to the exterior surface of the plank structure 10. The topcoat is then dried at a UV topcoat curing station 70.

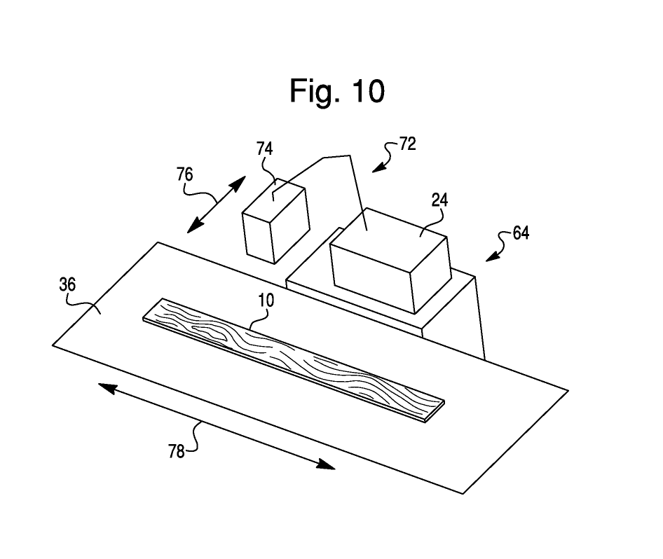

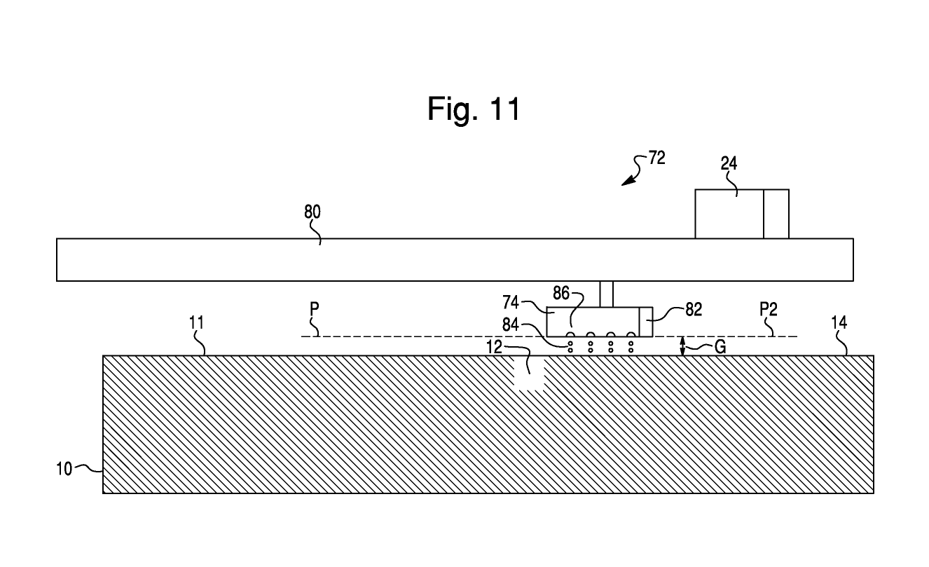

The printing station 64 will now be described in greater detail with reference to FIG. 10. The printing station 64 includes a printer 72 including at least one ink jet print head 74. The print head 74 is connected to the print control device 24 described above. The print head 74 is mounted for movement in a direction perpendicular to the direction of movement of the plank structure 10. Arrow 76 shows the direction of movement of the print head 74, and arrow 78 shows the direction of movement of the bed 36. The print head 74 is preferably movable along directions 76 across the entire width of the plank structure 10. The printer 72 may be a flat bed printer, such as available through Inca Digital Printers Limited of Cambridge, United Kingdom. An exemplary printing system is disclosed in U.S. Pat. No. 7,001,016, the disclosure if which is incorporated herein by reference.

As best shown in FIG. 11, the printer 72 may include a rail 80 for supporting the print head 74. The rail 80 provides for lateral movement of the print head 74 under the control of the print controller 24. The print head 74 is shown with a UV curing lamp 82 for drying and curing the ink jet ink. Alternatively, a separate curing station 66 (described above) may be provided. Ink jet ink droplets 84 are emitted from nozzles 86 of the print head 74.

The nozzle outlets of the print head 74 travel in a plane P2 that is separated from plane P of door structure 10 by a space G. Therefore, the distance traveled by ink droplets 84 emitted from nozzles 86 varies depending on whether the print head 74 is over the planar portion (e.g., major planar portion 11) or over one of the channels 12. If the distance is too great, the printed images may become blurred, particularly in the channels 12.

The nozzles 86 have a diameter of about 20 microns or more, e.g., about 30 microns or more or about 40 microns or more. The droplets 84 will have a diameter approximately equal to the diameter of the nozzles 86. For example, a Spectra NovaJet 256 print head may be used, which creates droplets having a diameter of about 40 microns. The relative speed of the print head 74 and the angle of the nozzles 86 relative to plane P2 (for example, the nozzles 86 may be tilted) defines the incident angle at which a droplet 84 is emitted from the nozzle 86 relative to the upper face of the plank structure 10.

It should be understood that the printer 72 may include multiple print heads 74 arranged in rows or arrays, so that each pass may effective print in more than one set of print grid positions. The nozzles 86 may emit droplets 84 of various desired colors in order to create a desired color.

It will be apparent to those of skill in the art that the foregoing embodiments present unique systems and methods for the extrusion industry which can be accomplished by combining one or more lasers with an extrusion machine in an on-line or off-line manner to print graphic patterns on the extruded material in a “print-on-the-fly” continuous process or by a intermittent indexing process. The system may incorporate an ink printing aspect to the extrusion/laser combination depending on the materials and articles being created. In particularly exemplary embodiment, this unique process utilizes the following elements:
Ultra high laser scan speed in excess of 10 meters per second, optionally in excess of 30 meters per second, optionally up to 50 meters per second;
High laser power of at least 1000 W and preferably 2500 W;
Controller to process a high number of pixels per second, preferably 50,000 pixels per second;
Encoder-to-feed line speed information to the laser to print on the fly during laser/extruder processes; and
Hardware and software to index patterns for a graphic repeat in a continuous process.

A typical extruder machine outputs material at a speed of 5-15 feet per minute. By utilizing an exemplary system possessing the above elements, current controller speed is substantially increased while indexing to properly laser etch materials traveling out of an extruder machine at 5-15 feet per minute.

It is noted that a controller board that will allow high speed information processing is particularly useful where highly detailed graphics having fine features are involved. Typically, the finer the pattern, the slower the laser scan speed. The reasoning is because when graphics are highly pixilated, the controller must slow down to read each change throughout the file. It is envisioned that very fine detailed designs may be required for products going through the extrusion process. However, by substantially increasing the controller speed, the laser scan speed will now be able to travel substantially faster and thus the line speed can be significantly increased. The controller speed can be measured in pixels per second. Typical controller speeds would operate at a maximum of about 10,000 pixels per second. In order to provide a high speed laser system to process high resolution graphics at scan speeds in excess of 5 meters/second and line speeds in excess of 5 feet per minute, the controller speed should be greater than 10,000 pixels per second and preferably 50,000 pixels per second.

With respect to the indexing of patterns, the file is indexed across the material as it is being extruded. For example, if the material was moving left to right, the pattern is set to match up traveling either in a horizontal or vertical direction. While traveling at high scan speeds, the laser preferably starts and stops at the exact locations within the file, or else the design will either show an overlap of pixels or gaps within the pattern.

It is believed that this laser print on-the-fly technology is scalable. Adding a second laser operating in tandem with the first laser will essentially double the line speed capability to 10-30 feet per minute. Further, the laser can print continuously in the vertical (across extruder processing line direction) or horizontal (along the extruder processing line direction). Also, the laser can continuously print raster and vector graphics in this system and such graphics can be, for example, patterns, logos, serial numbers, and other information. One envisioned application of this invention is to impart wood grain patterns with the laser on building material substrates such as decking, siding and trim product substrates made on an extrusion machine. Embodiments of the invention also apply to co-extrusion processes where top layers are extruded onto various substrates and the top layer is laser etched in a continuous print on the fly process.

As embodied herein, laser etching may be performed on articles having non-flat surfaces, such as a curvilinear surface. The laser may have a depth of field of several inches, allowing graphics to be laser etched on curved extruded parts in which the curvature depth does not exceed the depth of field of the laser. In other words, the laser will have a focal point with a certain degree of freedom (e.g., 2 inches), and curved parts may be laser etched so long as the depth of curvature does not exceed this degree of freedom dimension. Depth of field used here means the specific distance from the laser focal distance that the laser can still etch a noticeable graphic image on the substrate. If the laser attempts to etch a line outside of this depth of field, the line may not be visible on the substrate.

The foregoing detailed description of the certain exemplary embodiments of the invention has been provided for the purpose of explaining the principles of the invention and its practical application, thereby enabling others skilled in the art to understand the invention for various embodiments and with various modifications as are suited to the particular use contemplated. This description is not intended to be exhaustive or to limit the invention to the precise embodiments disclosed. Although only a few embodiments have been disclosed in detail above, other embodiments are possible and the inventors intend these to be encompassed within this specification and the scope of the appended claims. The specification describes specific examples to accomplish a more general goal that may be accomplished in another way. Modifications and equivalents will be apparent to practitioners skilled in this art and are encompassed within the spirit and scope of the appended claims and their appropriate equivalents. This disclosure is intended to be exemplary, and the claims are intended to cover any modification or alternative which might be predictable to a person having ordinary skill in the art. For example, other kinds and wattages of lasers, beyond those described above, could be used with this technique.

Only those claims which use the words “means for” are to be interpreted under 35 USC 112, sixth paragraph. Moreover, no limitations from the specification are to be read into any claims, unless those limitations are expressly included in the claims.

What is claimed is:

1. A combination extrusion and laser-marking system comprising:
an extruder operable to pass an extrudable material through a die and discharge an extrudate having a markable surface;
a laser operable continuously with the extruder for forming an image on the markable surface of the extrudate discharged from the extruder; and
a controller system operable to measure a rate of speed at which the extrudate is discharged from the extruder and provide a feedback signal for controlling operation of the laser.

2. The system of claim 1, wherein said feedback signal is adapted to coordinate operation of the extruder and the laser

3. The system of claim 1, wherein the laser is operable at scan speeds in excess of 10 meters per second.

4. The system of claim 1, wherein the laser is operable at scan speeds in excess of 30 meters per second.

5. The system of claim 1, wherein the laser is operable at least 1000 W.

6. The system of claim 1, wherein the laser is operable at least 2500 W.

7. The system of claim 1, further comprising a galvanometer for driving the laser.

8. The system of claim 1, wherein said laser system further comprises a controller board with controller speeds of at least 50,000 pixels per second.

9. The system of claim 1, wherein said laser system controls said laser to define a depth of field of said laser, wherein the extruded article is at least partly curved in shape in at least one area curved area and said the curvature depth does not exceed the depth of field of the laser.

10. The system of claim 1, further comprising an indexing system for indexing patterns within a predetermined area on said extruded article in a process whereby said patterns are compiled to define said image on said surface of said extruded article.

11. A method for extruding an article and creating an image in a surface of the article, the method comprising:
extruding an extrudable material through a die to provide an extrudate;
delivering the extrudate to a processing line;
lasing a surface of the extrudate on the processing line to form said image;
measuring a rate of movement of the processing line with a controller;
generating a feedback signal based on the measured rate of movement; and
adjusting said lasing based on said feedback signal to coordinate the steps of extruding said extruded article and lasing said surface to form said image.

12. The method according to claim 11, further comprising a step of indexing patterns within a predetermined area on said extruded article in a continuous process whereby a series of discrete images are compiled to define said image on said surface of said extruded article.

13. The method according to claim 11, wherein said step of applying a laser comprises a step of controlling said laser to define a depth of field of said laser, wherein the extruded article is at least partly curved in shape in at least one area curved area and said the curvature depth does not exceed the depth of field of the laser.

14. The method according to claim 11, further comprising a step of ink printing on said extruded article.

15. The method according to claim 14, wherein said step of ink printing on said extruded article is performed before said step of lasing.

16. An extruded article made by the method of claim 11.

17. The extruded article according to claim 16, wherein the image lazed on the surface increases a frictional coefficient of said surface to provide slip resistance to the substrate.

18. A combination laser marking system and an extrusion system for applying a laser to an extruded article off-line of the extrusion process thereby creating an image on a surface of said extruded article, said combination comprising:
a laser system for applying a laser to form an image on a surface of said extruded article; and
a controller system to measure a speed of said extrusion line and delivering a feedback signal to said laser system to control the laser system based on said feedback signal.

19. The combination according to claim 18, wherein said laser system provides scan speeds in excess of 10 meters per second and, preferably at least 30 meters per second.

20. The combination according to claim 18, wherein said laser system includes a laser with a power of at least 1000 W, and preferably at least 2500 W.
